(19) United States
(12) Patent Application Publication
(10) Pub. No.: US 2026/0316777 A1
(43) Pub. Date: Oct. 15, 2026

(54) APPARATUS AND METHOD FOR DIAGNOSING A DRIVETRAIN FAILURE OF A MOBILITY APPARATUS

(71) Applicants: HYUNDAI MOTOR COMPANY, Seoul (KR); KIA CORPORATION, Seoul (KR); GWANGJU INSTITUTE OF SCIENCE AND TECHNOLOGY, Gwangju (KR)

(72) Inventors: Kyung Woo Lee, Hwaseong-si (KR); Dae Un Sung, Hwaseong-si (KR); Young Rock Chung, Hwaseong-si (KR); Jun Gyu Lee, Hwaseong-si (KR); Jeong Min Oh, Busan (KR); Hyun Seok Oh, Gwangju (KR)

(73) Assignees: HYUNDAI MOTOR COMPANY, Seoul (KR); KIA CORPORATION, Seoul (KR); GWANGJU INSTITUTE OF SCIENCE AND TECHNOLOGY, Gwangju (KR)

(21) Appl. No.: 19/400,830

(22) Filed: Nov. 25, 2025

(30) Foreign Application Priority Data
Apr. 14, 2025 (KR) 10-2025-0047958

(51) Int. Cl. B60W 50/14; B60W 50/00; B60W 50/02; G06N 3/08

(52) U.S. Cl. CPC B60W 50/14; B60W 50/0097; B60W 50/0205; G06N 3/08; B60W 2050/0057; B60W 2050/021; B60W 2050/146

(57) ABSTRACT

An apparatus for diagnosing a mobility apparatus includes an input unit configured to obtain a first noise or vibration signal at a first point while a driving force of the mobility apparatus is generated, and a control unit configured to transform the first noise or vibration signal into a frequency-domain signal, obtain one or more high-dimensional feature factors by a Fourier feature embedding neural network, predict noise or vibration data for a component in association with the driving force using a transfer function estimation model, and diagnose the component based on the noise or vibration data. The apparatus further includes a display unit configured to display a predicting result and a diagnosing result in one or more of a display form that is visually recognizable by the driver.

### CROSS-REFERENCE TO RELATED APPLICATIONS

This application claims priority to and benefits of Korean Patent Application No. 10-2025-0047958 under 35 U.S.C. § 119 filed on May 14, 2025, in the Korean Intellectual Property Office, the entire contents of which are incorporated herein by reference.

### FIELD

The present disclosure generally relates to an apparatus and method for diagnosing a failure in a drivetrain of a mobility apparatus.

### BACKGROUND

Driving comfort or sensibility has become increasingly important in recent years, and noise and vibration experienced by drivers has also become an important factor in terms of the commercial value of vehicles. Therefore, recognizing and dealing properly with noise and vibration generated as a drivetrain of a vehicle deteriorates is important. However, the accuracy of identifying abnormality of a drivetrain of a mobility apparatus (i.e., a noise point, e.g., a motor reducer) using noise and vibration signals at a driver's seat (i.e., a noise-receiving point) is generally low due to external noise.

To overcome this challenge, a vehicle transfer function, i.e., a transfer path analysis, may be used to convert the noise and vibration signals at the noise-receiving point into noise and vibration signals at the noise point, or a noise source, and identify the abnormality of the drivetrain of the mobility apparatus. However, modeling the vehicle transfer function in a typical way may require making a vehicle in a trimmed body state and performing a frequency response function test separately on each part, which may require repeated disassembly, assembly, and measurement, consuming a great amount of time and cost to model the vehicle transfer function.

In addition, acceleration data obtained during driving and a deep learning model may be used to model the vehicle transfer function, but a spectral bias inherent in the deep learning model may make it difficult to obtain high-resolution data of vibration peaks, for example.

The above information disclosed in this Background section is only for understanding of the background of the disclosure, and, therefore, it may contain information that does not constitute prior art.

### SUMMARY

An aspect of the present disclosure is directed to a diagnostic apparatus and method to reduce a spectral bias when diagnosing a failure in a drivetrain, which is a means providing power, such as an internal combustion engine or an electric motor, in a mobility apparatus.

Another aspect of the present disclosure is directed to an apparatus and method for diagnosing a failure in a drivetrain of a mobility apparatus, which may predict noise and/or vibration at a noise point based on noise and/or vibration data detected at a noise-receiving point, such as, for example, a driver's seat of a vehicle.

The apparatus and method for diagnosing a failure in a drivetrain of a mobility apparatus according to the aspects of the present disclosure may apply Fourier feature embedding when estimating a signal of a noise point through a neural network in a vehicle domain to relieve a spectral bias.

According to an aspect of the present disclosure, an apparatus for diagnosing a mobility apparatus is provided. The apparatus includes: an input unit including one or more sensors configured to obtain a first noise or vibration signal at a first point while a driving force of the mobility apparatus is generated, a control unit configured to transform the first noise or vibration signal into a frequency-domain signal and obtain one or more high-dimensional feature factors by a Fourier feature embedding neural networks, and predict noise or vibration data for a component in association with the driving force using a transfer function estimation model and diagnose the component based on the noise or vibration data, and a display unit configured to display a predicting result and a diagnosing result in one or more of a display form that is visually recognizable by the driver.

The apparatus may further comprise a prediction model training unit configured to determine a transfer path of noise or vibration from a second point to the first point and generate the transfer function estimation model by transforming frequency data of the first noise or vibration signal and a second noise or vibration signal obtained at the second point into one or more high-dimensional feature factors through the Fourier feature embedding neural network, and a storage unit configured to store information about the transfer function estimation model.

The Fourier feature embedding neural network may be configured to transform a result of a Fourier transformation into a high-dimensional feature vector with a nonlinear transformation applied.

The prediction model training unit may be further configured to generate a first transfer function estimation model configured to generate frequency data indicative of noise or vibration at an intermediate point between the first point and the second point using the frequency data of the first noise or vibration signal based on a second noise or vibration signal and a third noise or vibration signal obtained at the intermediate point, and a second transfer function estimation model configured to generate the frequency data of the second noise or vibration signal using the frequency data indicative of the noise or vibration at the intermediate point based on the third noise or vibration signal and the first noise or vibration signal.

The transfer function estimation model may include a plurality of computational blocks and at least a fully connected block, wherein each of the plurality of computational blocks is subject to a kernel.

The transfer function estimation model may comprise a plurality of computational blocks and at least a fully connected block, wherein each of the plurality of computational blocks is subject to a kernel and the prediction model training unit is further configured to determine weights and biases of the kernel through deep learning.

The second point may comprise a point in association with obtaining a noise or vibration signal for a motor reducer, a brake, a tire, or any combination of the motor reducer, the brake, the tire in the mobility apparatus, and the first point comprises a point at a driver's seat of the mobility apparatus.

The second point may include a point at a motor or a reducer, and the intermediate point includes a point at each of a motor or reducer mount, a subframe mount, or a shock absorber top mount.

The input unit may be further configured to obtain the first noise or vibration signal from at least a first sensor located within a predetermined range from the first point, obtain the second noise or vibration signal from at least a second sensor located within a predetermined range from the second point, and obtain the third noise or vibration signal from a third sensor located within a predetermined range from the intermediate point.

The input unit may be further configured to receive, from an external device, data indicative of failure information of a motor or a reducer.

The storage unit may be further configured to store the first noise or vibration signal, the second noise or vibration signal, the third noise or vibration signal, or data indicative of failure information of a motor or a reducer at a time of measuring the first noise or vibration signal, the second noise or vibration signal, or the third noise or vibration signal.

The prediction model training unit may be further configured to train the Fourier feature embedding neural network with a spectrum with a data length of 640 as a batch size for 1350 iterations and use an adaptive moment estimation (Adam) algorithm to minimize a loss function.

According to another aspect of the present disclosure, a method for diagnosing a failure in a drivetrain of a mobility apparatus is provided. The method includes: generating first point data transformed into a frequency domain from a first noise or vibration signal measured at a first point while a driving force of the mobility apparatus is generated, transforming frequency data of the first point data into one or more high-dimensional feature factors by a Fourier feature embedding neural network, reading a transfer function estimation model stored in a storage unit, predicting second point data for a second point by applying, to the transfer function estimation model, the one or more high-dimensional feature factors, and determining validity of the predicted second point data.

The method may further include training the Fourier feature embedding neural network to generate the transfer function estimation model.

The method may further include displaying a result of determining the validity of the second point data in a form recognizable by a driver.

The method may further include generating intermediate point data transformed into the frequency domain from a third noise or vibration signal obtained by at least an intermediate point between the first point and the second point. In particular, the transfer function estimation model comprises: a first transfer function estimation model configured to generate frequency data indicative of noise or vibration of the intermediate point from the frequency data of the first noise or vibration signal based on a second noise or vibration signal obtained at the second point and the third noise or vibration signal; and a second transfer function estimation model configured to generate frequency data indicative of the second noise or vibration from the frequency data indicative of the noise or vibration of the intermediate point based on the third noise or vibration signal and the first noise or vibration signal.

Weights and biases of the kernel may be determined through deep learning.

The second point may include a point at a motor or a reducer, and the intermediate point includes a point at each of a motor or reducer mount, a subframe mount, or a shock absorber top mount.

According to an aspect of the present disclosure, a vehicle diagnosing system for diagnosing a mobility apparatus is provided. The vehicle diagnosing system comprises: an input unit configured to obtain a first noise or vibration signal at a first point while a driving force of the mobility apparatus is generated; a control unit configured to transform the first noise or vibration signal into a frequency-domain signal, extract one or more high-dimensional feature factors by a Fourier feature embedding neural network, predict noise or vibration data for a component using a transfer function estimation model, and diagnose whether the component based on the noise or vibration data is in a normal state; and a display unit configured to display a prediction result and a validity determination result of predicted data in a form recognizable to a driver of a vehicle.

The apparatus and method for diagnosing a failure in a drivetrain of a mobility apparatus according to the aspects of the present disclosure may solve a challenge caused by a spectral bias; determine the abnormality of the drivetrain of the mobile device by predicting noise point data using noise and vibration signals of a noise-receiving point at any point in time; and accurately determine and respond to deterioration of the drivetrain of the mobile device, to reduce the time and cost used for vehicle maintenance, increase driving comfort or sensibility of a vehicle driver, and improve vehicle customer's satisfaction.

It is to be understood that both the foregoing general description and the following detailed description are exemplary and explanatory and are intended to provide further explanation of the disclosure as claimed.

### BRIEF DESCRIPTION OF THE DRAWINGS

FIG. 1 is a schematic block diagram illustrating a configuration of an apparatus for diagnosing a failure in a drivetrain of a mobility apparatus according to an embodiment of the present disclosure.

FIG. 2 is a schematic flow diagram illustrating a method of diagnosing a failure in a drivetrain of a mobility apparatus according to an embodiment of the present disclosure.

FIG. 3 is a schematic flow diagram illustrating a process of generating a transfer function estimation model of FIG. 2.

FIG. 4 is a schematic diagram illustrating an example of a Fourier feature embedding neural network operation implemented in an apparatus and method for diagnosing a failure in a drivetrain of a mobility apparatus according to an embodiment of the present disclosure.

FIG. 5 is a schematic diagram illustrating an example of embedding through a total of 512 values of b based on an input of a vibration amplitude corresponding to a 60th order component in an apparatus for diagnosing a failure in a drivetrain of a mobility apparatus according to an embodiment of the present disclosure.

FIG. 6A and FIG. 6B are schematic diagrams illustrating, respectively, a comparative example with Fourier feature embedding neural network not applied and an example of a predicted drivetrain signal by a transfer function model through deep learning with the Fourier feature embedding neural network applied according to an embodiment of the present disclosure.

### DETAILED DESCRIPTION

The following detailed structural or functional description of embodiments of the present disclosure is provided only for the purpose of providing examples, and various modifications and changes may be made to the examples. Here, the examples are not construed as limited to the disclosure and should be understood to include all changes, equivalents, and replacements within the idea and the technical scope of the disclosure.

The features may be embodied in different forms and are not to be construed as being limited to the examples described herein. Rather, the examples have been provided merely to illustrate some of the many possible ways of implementing the methods, apparatuses, and/or systems that will be apparent after an understanding of the disclosure of this application.

Although terms such as first, second, and the like are used to describe various components, the components are not limited to these terms. These terms should be used only to distinguish one component from another component. For example, a first component may be referred to as a second component, and similarly the second component may also be referred to as the first component, without departing from the scope of appended claims.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing. Similarly, expressions, for example, “disposed on” may be construed that a component or element is disposed directly on the surface of another component or element or above the surface of the other component or element, spaced apart from the surface.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the disclosure of the present application and is not to be interpreted in an idealized or overly formal sense unless expressly so defined herein.

In other embodiments, the functions, operations, or steps specified within particular blocks may occur in a different order as opposed to specified in the flowcharts. For example, two consecutive blocks may actually be performed substantially simultaneously, or the blocks may be performed in reverse order, depending on the functions, operations, or steps involved.

Hereinafter, an apparatus and method for diagnosing a failure in a drivetrain of a mobility apparatus, or simply a mobility apparatus drivetrain failure diagnosing apparatus and method, according to various embodiments of the present disclosure, will be described with reference to the accompanying drawings.

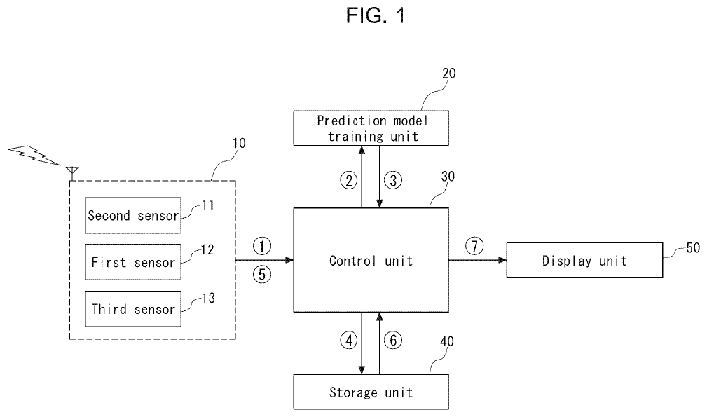

FIG. 1 is a schematic block diagram illustrating a configuration of a mobility apparatus drivetrain failure diagnosing apparatus according to an embodiment of the present disclosure. A mobility apparatus may refer to a device of various types designed to assist a person or object in moving or traveling. The mobility apparatus may enhance individual mobility or movability, increase the convenience and efficiency of travel, and overcome obstacles or physical constraints. The mobility apparatus may be implemented in various forms including, as non-limiting examples, a vehicle, a flying vehicle, a ship, or the like that uses an electric or internal combustion engine as a power source to travel. Although the following description uses a “vehicle” as an example of the mobility apparatus, examples of the mobility apparatus are not limited to a vehicle.

A mobility apparatus drivetrain failure diagnosing apparatus 100 may be a computing device that implements various embodiments of the present disclosure. For example, the mobility apparatus drivetrain failure diagnosing apparatus 100 may include at least one processor and memory, with the memory including computer-readable instructions and the at least one processor executing the instructions stored in the memory, to implement various embodiments of the present disclosure.

A “processor” may refer to a configuration that processes computational operations, logic operations, determination operations, or the like to provide at least one function, which may be implemented in software, hardware, or a combination of software and hardware. For example, the processor may be implemented in software such as a task, class, subroutine, process, object, execution thread, or program that is executed in a predetermined area of the memory, in hardware such as a field-programmable gate array (FPGA) or application-specific integrated circuit (ASIC), or in a combination of software and hardware. The processor may be included in a computer-readable storage medium or distributed in a plurality of computers.

For example, the mobility apparatus drivetrain failure diagnosing apparatus 100 may be implemented as a supercomputer, server, mainframe, workstation, personal computer (PC), laptop computer, tablet computer, embedded computer, wearable computer, or the like, but the scope of examples of which is not limited thereto, and the mobility apparatus drivetrain failure diagnosing apparatus 100 may be any computing device capable of implementing various embodiments of the present disclosure.

In some embodiments of the present disclosure, the mobility apparatus drivetrain failure diagnosing apparatus 100 may be implemented as a single computing device or as a plurality of computing devices.

Although the mobility apparatus drivetrain failure diagnosing apparatus 100 is as diagnosing a failure in a vehicle, it is not limited thereto and may be applied to various traveling and transportation means using internal combustion engines or electric motors as their power sources.

A vehicle may be a representative example of the mobility apparatus, of a concept that may include all types of electric vehicles having an electric motor as a power source.

As shown in FIG. 1, the mobility apparatus drivetrain failure diagnosing apparatus 100 according to an embodiment of the present disclosure may include an input unit 10, a prediction model training unit 20, a control unit 30, a storage unit 40, and a display unit 50.

The input unit 10 may obtain vibration signals of a noise point, an intermediate point, and a noise-receiving point according to a control signal provided from the control unit 30. The vibration signals may represent time-domain data and frequency band-specific vibration acceleration levels of the vibration signals with respect to three measurement directions including an x-axis, a y-axis, and a z-axis at the noise point, the intermediate point, and the noise-receiving point.

As a vehicle operates, noise may be generated in various parts of the vehicle. A noise generating point (may be referred to as the “noise point” or a “second point”) in the vehicle may be various points in the vehicle from which noise may be generated, such as, for example, parts of a drivetrain of the vehicle (e.g., a motor or a reducer, brakes, tires, or the like). A user in the vehicle may sense noise generated from this noise point. A point (may be referred to as the “noise-receiving point” or a “first point”) at which the user may detect the noise generated from the noise point may be, for example, a driver's seat in the vehicle. Hereinafter, for ease of explanation, a point located within a predetermined range based on a position of a part corresponding to the noise point (e.g., a motor or a reducer of a vehicle) will be referred to as a noise point. The vehicle may include one or more intermediate points (may be referred to as “third points”) between the noise point and the noise-receiving point to connect a part of the drivetrain or the like corresponding to the noise point to the vehicle. The intermediate point may represent a point in the middle connected to the noise point and the noise-receiving point in the vehicle. For example, based on the noise point being a motor reducer, the motor reducer may be electrically connected to the vehicle via each of a motor reducer mount, a subframe mount, and a shock absorber top mount. The respective points of the motor reducer mount, the subframe mount, and the shock absorber top mount may be intermediate points between the noise point and the noise-receiving point. Hereinafter, for ease of explanation, one or more intermediate points, or at least one intermediate point, may be, for example, three intermediate points.

When noise is generated from the noise point, the noise may be sensed by sensors at various positions. The vibration of the noise may be transferred through multiple parts to the at least one intermediate point, the noise-receiving point, or the like, and a signal feature may change during the transfer to the at least one intermediate point, the noise-receiving point, or the like. The vibration with the changed signal feature may be measured by sensors located at the at least one intermediate point, the noise-receiving point, or the like.

The input unit 10 may obtain a vibration signal from at least one second sensor 11 located within a predetermined range relative to the noise point, a vibration signal from at least one first sensor 12 located within a predetermined range relative to the noise-receiving point, and a vibration signal from at least one third sensor 13 located within a predetermined range relative to each of the at least one intermediate point.

The prediction model training unit 20 may receive the vibration signals of the noise point and the noise-receiving point from the input unit 10 through the control unit 30, and transform frequency data into high-dimensional feature factors through Fourier feature embedding neural network to establish a transfer path between the noise point and the noise-receiving point and generate a transfer function estimation model.

The transfer function estimation model generated by the prediction model training unit 20 may include a plurality of computational blocks and at least one fully connected block, and a kernel may be applied to each of the plurality of computational blocks. The prediction model training unit 20 may determine weights and biases of the kernel through deep learning.

The prediction model training unit 20 may estimate a transfer function between data indicative of vibration at the noise point and data indicative of vibration at the noise-receiving point based on deep learning, and may predict a vibration signal at the noise point from a vibration signal collected at the noise-receiving point based on the estimated transfer function. Deep learning may be implemented through various models including, as non-limiting examples, a convolutional neural network (CNN) model and a multi-layer perceptron (MLP) model. The CNN model may extract a feature map from data, simplify the feature map, and transform the dimensions of the simplified feature map into a one-dimensional vector through a flatten layer to perform a learning process.

The control unit 30 may transform the vibration signal at the noise-receiving point (e.g., a driver's seat) received at a testing time from the input unit 10 into a frequency-domain signal, extract a high-dimensional feature factor from frequency data by Fourier feature embedding neural network, predict noise point data using the transfer function estimation model stored in the storage unit 40, and diagnose whether the motor reducer of the vehicle is in a normal state based on the noise point data.

Although the prediction model training unit 20 and the control unit 30 are shown as different components in the block diagram, this is for functional description. That is, both the prediction model training unit 20 and the control unit 30 may function as a “processor.” A “processor” may refer to a configuration that processes computational operations, logic operations, determination operations, or the like to provide at least one function, which may be implemented in software, hardware, or a combination of software and hardware. For example, the processor may be implemented in software such as a task, class, subroutine, process, object, execution thread, or program that is executed in a predetermined area of a memory, in hardware such as a field-programmable gate array (FPGA) or application-specific integrated circuit (ASIC), or in a combination of software and hardware. The processor may be included in a computer-readable storage medium or distributed in a plurality of computers.

The storage unit 40 may receive, from the control unit 30, information about the transfer function estimation model generated by the prediction model training unit 20 and store the information. The storage unit 40 may include a storage medium of one or more memory types such as a flash memory type, hard disk type, micro type, card type (e.g., a secure digital (SD) card or an extreme digital (XD) card), or the like, and a random-access memory (RAM), static RAM (SRAM), read-only memory (ROM), programmable (PROM), electrically erasable PROM (EEPROM), magnetic RAM (MRAM), magnetic disk, and optical disk type.

The display unit 50 may display a prediction result and a validity determination result of predicted data in a form recognizable to a driver of the vehicle according to a control signal of the control unit 30. The display unit 50 may display the prediction result and diagnosis result in one or more of a display form that is visually recognizable by the driver and a sound form that is audibly recognizable by the driver.

The prediction model training unit 20 may receive vibration/noise signals of the noise point, the noise-receiving point, and the intermediate point between the noise point and the noise-receiving point at a learning time (e.g., a first time point) for generating the transfer function estimation model. The control unit 30 may receive vibration/noise signals of the noise-receiving point at a testing time (e.g., a second time point).

To relieve a spectral bias, the mobility apparatus drivetrain failure diagnosing apparatus according to an embodiment of the present disclosure may have the prediction model training unit 20 and the control unit 30 that apply Fourier feature embedding neural network to map noise-receiving point data into high-dimensional feature factors. The Fourier feature embedding neural network may refer to transforming a result of a Fourier transformation into a high-dimensional feature vector with a nonlinear transformation applied, to facilitate deep learning, by a neural network, on vibration data transformed into frequency components.

The input unit 10 may obtain a vibration signal of the at least one intermediate point between the noise point and the noise-receiving point, and the control unit 30 may transform the vibration signal of the at least one intermediate point into a frequency-domain signal and extract a high-dimensional feature factor of the intermediate point by Fourier feature embedding neural network. The prediction model training unit 20 may generate a first transfer function estimation model configured to generate frequency data indicative of vibration of the intermediate point from frequency data indicative of vibration of the noise-receiving point, and a second transfer function estimation model configured to generate frequency data indicative of vibration of the noise point from the frequency data indicative of the vibration of the intermediate point.

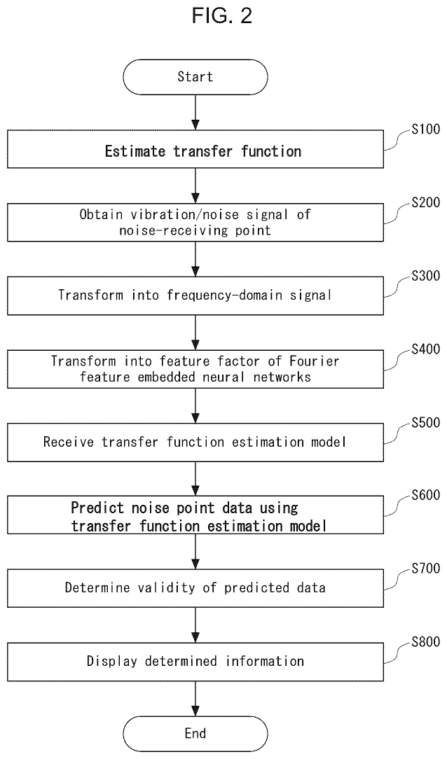

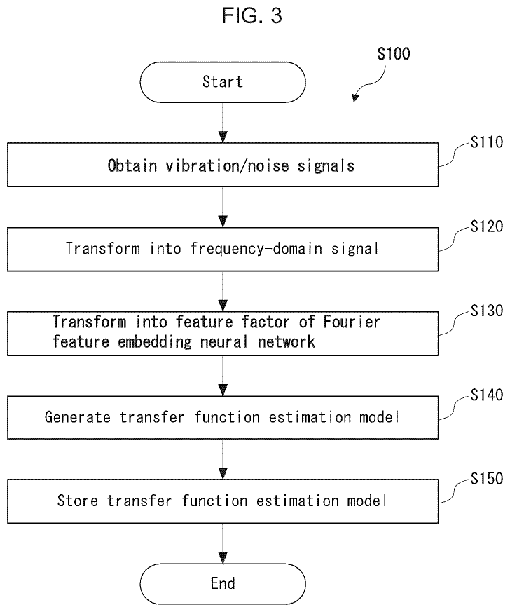

FIG. 2 is a schematic flow diagram illustrating a mobility apparatus drivetrain failure diagnosing method according to an embodiment of the present disclosure. FIG. 3 is a schematic flow diagram illustrating a process of generating a transfer function estimation model of FIG. 2.

As shown, the mobility apparatus drivetrain failure diagnosing method according to an embodiment of the present disclosure may include a step S100 (i.e., learning step including \textcircled{1}, \textcircled{2}, \textcircled{3}, and \textcircled{4} in FIG. 1) for estimating a transfer function, a step S200 (\textcircled{5} in FIG. 1) for obtaining a vibration/noise signal at a noise-receiving point at a diagnosis time (or a testing time) for diagnosing a failure in a drivetrain of a mobility apparatus, a step S300 for transforming a time-domain vibration signal into frequency-domain data, a step S400 for transforming the frequency-domain data into a high-dimensional feature factor by applying Fourier feature embedding neural network, a step S500 (\textcircled{6} in FIG. 1) for receiving transfer function estimation model information; a step S600 for predicting noise point data using the transfer function estimation model, a step S700 for determining the validity of the predicted noise point data, and a step S800 (\textcircled{7} in FIG. 1) for displaying determined information such as the validity of the predicted noise point data to a driver of a vehicle (S800).

Here, learning to generate a transfer function estimation model for estimating the noise point data of the vehicle may precede. The step S100 for estimating the transfer function may be performed in a sequential order shown in FIG. 3.

The input unit 10 may obtain vibration/noise signals at the noise point, the intermediate point, and the noise-receiving point (\textcircled{1} in FIG. 1). The vibration/noise signals obtained by the input unit 10 may be transferred to the prediction model training unit 20 (\textcircled{2} in FIG. 1) (S110).

The prediction model training unit 20 may transform a vibration/noise signal of each point received via the control unit 30 into a frequency-domain signal. That is, it may transform collected time-domain vibration/noise signals into frequency-domain data using a fast Fourier transform (FFT). In general, vibration/noise data may be a signal collected in a time domain and may be transformed into a frequency domain, extracting richer information (S120).

The prediction model training unit 20 may transform frequency data into a high-dimensional feature vector by Fourier feature embedding neural network of the vibration/noise signal transformed into the frequency-domain data. When generating a deep learning model, high-frequency information may not be appropriately learned sometimes. For example, Fourier feature embedding neural network may be used to transform frequency information into a high-dimensional representation and retain information from high-frequency components in addition to low-frequency components. Fourier feature embedding neural network may refer to a technique for transforming a signal into a high-dimensional vector that includes frequency information, which may assist a neural network or machine learning model in learning more complex patterns. It may also analyze which frequency band a particular noise is strongly present in data represented as a combination of different frequency components by a Fourier transformation (e.g., FFT). In other words, it may generate a vector representation including frequency information and transform it into a high-dimensional feature factor. This process may nonlinearly transform the frequency components to extract a feature that includes a wider variety of frequency components and phase information than original data to be more expressive (S130).

The prediction model training unit 20 may use the extracted data to establish a transfer path between the noise point and the noise-receiving point, and generate a transfer function estimation model (S140) and transmit it to the control unit 30 (FIG. 1, \textcircled{3}), and the control unit 30 may store the generated transfer function estimation model in the storage unit 40 (S150) (FIG. 1, \textcircled{4}).

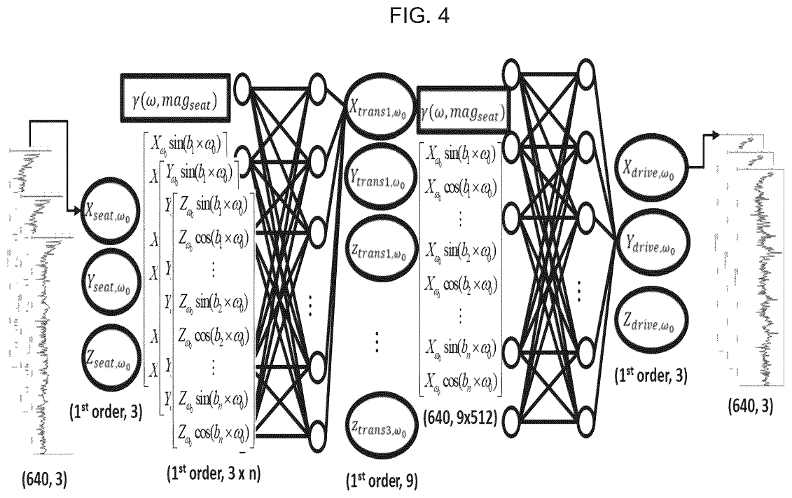

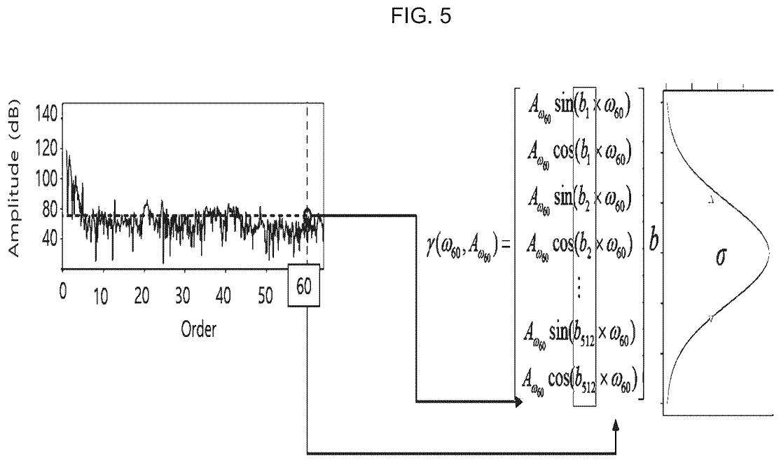

FIG. 4 is a schematic diagram illustrating an example of a Fourier feature embedding neural network operation implemented in an apparatus and method for diagnosing a failure in a drivetrain of a mobility apparatus according to an embodiment of the present disclosure, and FIG. 5 is a schematic diagram illustrating an example of embedding through a total of 512 values of b based on an input of a vibration amplitude corresponding to a 60th order component in an apparatus for diagnosing a failure in a drivetrain of a mobility apparatus according to an embodiment of the present disclosure.

This process of generating a transfer function model using a Fourier feature embedding neural network may be performed as shown in FIG. 4. An embodiment in FIG. 4 shows learning on one spectrum with a data length of 640. Here, amplitude values of a vibration signal may be sequentially input, and features of frequency data may be extracted using an embedding function.

An amplitude of a vibration signal at a driver's seat may include three dimensions of Xₛₑₐₜ, Yₛₑₐₜ, and Zₛₑₐₜ in three directions. A Fourier feature embedding function γ for three first orders (X_{seat,ω0}, Y_{seat,ω0}, Z_{seat,ω0}) may be used to embed amplitude data of a corresponding frequency component into a higher-dimensional feature factor. A Fourier feature embedding function γ(ω,magₛₑₐₜ), where \dot{u} denotes a frequency component of a vibration signal and magₛₑₐₜ denotes an amplitude value at a driver's seat, may be applied. For example, the Fourier feature embedding function γ(ω,magₛₑₐₜ) at the driver's seat under the condition where b∈{1, 2, . . . , n}, ωi, i∈{0, 1, . . . , k} may be applied as follows. Here, b denotes a hyperparameter used to embed data into a feature factor with a frequency component. In a first order, the Fourier feature embedding neural network at the noise-receiving point, i.e., the driver's seat, may be represented by the following matrix. For example, when the value of b increases from 1 to n, based on ω₀, the x-axis, y-axis, and z-axis frequency data may be represented as follows.

$$[ \begin{matrix}{X}_{seat , ω0} sin ( {b}_{1} \times {ω}_{0} ) \\ {X}_{seat , ω0} cos ( {b}_{1} \times {ω}_{0} ) \\ {X}_{seat , ω0} sin ( {b}_{2} \times {ω}_{0} ) \\ {X}_{seat , ω0} cos ( {b}_{2} \times {ω}_{0} ) \\ ⋮ \\ {X}_{seat , ω0} sin ( {b}_{n} \times {ω}_{0} ) \\ {X}_{seat , ω0} cos ( {b}_{n} \times {ω}_{0} )\end{matrix} ] [ \begin{matrix}{Y}_{seat , ω0} sin ( {b}_{1} \times {ω}_{0} ) \\ {Y}_{seat , ω0} cos ( {b}_{1} \times {ω}_{0} ) \\ {Y}_{seat , ω0} sin ( {b}_{2} \times {ω}_{0} ) \\ {Y}_{seat , ω0} cos ( {b}_{2} \times {ω}_{0} ) \\ ⋮ \\ {Y}_{seat , ω0} sin ( {b}_{n} \times {ω}_{0} ) \\ {Y}_{seat , ω0} cos ( {b}_{n} \times {ω}_{0} )\end{matrix} ] [ \begin{matrix}{Z}_{seat , ω0} sin ( {b}_{1} \times {ω}_{0} ) \\ {Z}_{seat , ω0} cos ( {b}_{1} \times {ω}_{0} ) \\ {Z}_{seat , ω0} sin ( {b}_{2} \times {ω}_{0} ) \\ {Z}_{seat , ω0} cos ( {b}_{2} \times {ω}_{0} ) \\ ⋮ \\ {Z}_{seat , ω0} sin ( {b}_{n} \times {ω}_{0} ) \\ {Z}_{seat , ω0} cos ( {b}_{n} \times {ω}_{0} )\end{matrix} ]$$

When the value of b increases from 1 to n, based on ω₁, the x-axis, y-axis, and z-axis frequency data may be represented as follows.

$$[ \begin{matrix}{X}_{seat , ω1} sin ( {b}_{1} \times {ω}_{1} ) \\ {X}_{seat , ω1} cos ( {b}_{1} \times {ω}_{1} ) \\ {X}_{seat , ω1} sin ( {b}_{2} \times {ω}_{1} ) \\ {X}_{seat , ω1} cos ( {b}_{2} \times {ω}_{1} ) \\ ⋮ \\ {X}_{seat , ω1} sin ( {b}_{n} \times {ω}_{1} ) \\ {X}_{seat , ω1} cos ( {b}_{n} \times {ω}_{1} )\end{matrix} ] [ \begin{matrix}{Y}_{seat , ω1} sin ( {b}_{1} \times {ω}_{1} ) \\ {Y}_{seat , ω1} cos ( {b}_{1} \times {ω}_{1} ) \\ {Y}_{seat , ω1} sin ( {b}_{2} \times {ω}_{1} ) \\ {Y}_{seat , ω1} cos ( {b}_{2} \times {ω}_{1} ) \\ ⋮ \\ {Y}_{seat , ω1} sin ( {b}_{n} \times {ω}_{1} ) \\ {Y}_{seat , ω1} cos ( {b}_{n} \times {ω}_{1} )\end{matrix} ] [ \begin{matrix}{Z}_{seat , ω1} sin ( {b}_{1} \times {ω}_{1} ) \\ {Z}_{seat , ω1} cos ( {b}_{1} \times {ω}_{1} ) \\ {Z}_{seat , ω1} sin ( {b}_{2} \times {ω}_{1} ) \\ {Z}_{seat , ω1} cos ( {b}_{2} \times {ω}_{1} ) \\ ⋮ \\ {Z}_{seat , ω1} sin ( {b}_{n} \times {ω}_{1} ) \\ {Z}_{seat , ω1} cos ( {b}_{n} \times {ω}_{1} )\end{matrix} ]$$

When the value of b increases from 1 to n, based on ωₖ as the value of i in ωᵢ increases to the value of k, the x-axis, y-axis, and z-axis frequency data may be represented as follows.

$$[ \begin{matrix}{X}_{seat , ω k} sin ( {b}_{1} \times {ω}_{k} ) \\ {X}_{seat , ω k} cos ( {b}_{1} \times {ω}_{k} ) \\ {X}_{seat , ω k} sin ( {b}_{2} \times {ω}_{k} ) \\ {X}_{seat , ω k} cos ( {b}_{2} \times {ω}_{k} ) \\ ⋮ \\ {X}_{seat , ω k} sin ( {b}_{n} \times {ω}_{k} ) \\ {X}_{seat , ω k} cos ( {b}_{n} \times {ω}_{k} )\end{matrix} ] [ \begin{matrix}{Y}_{seat , ω k} sin ( {b}_{1} \times {ω}_{k} ) \\ {Y}_{seat , ω k} cos ( {b}_{1} \times {ω}_{k} ) \\ {Y}_{seat , ω k} sin ( {b}_{2} \times {ω}_{k} ) \\ {Y}_{seat , ω k} cos ( {b}_{2} \times {ω}_{k} ) \\ ⋮ \\ {Y}_{seat , ω k} sin ( {b}_{n} \times {ω}_{k} ) \\ {Y}_{seat , ω k} cos ( {b}_{n} \times {ω}_{k} )\end{matrix} ] [ \begin{matrix}{Z}_{seat , ω k} sin ( {b}_{1} \times {ω}_{k} ) \\ {Z}_{seat , ω k} cos ( {b}_{1} \times {ω}_{k} ) \\ {Z}_{seat , ω k} sin ( {b}_{2} \times {ω}_{k} ) \\ {Z}_{seat , ω k} cos ( {b}_{2} \times {ω}_{k} ) \\ ⋮ \\ {Z}_{seat , ω k} sin ( {b}_{n} \times {ω}_{k} ) \\ {Z}_{seat , ω k} cos ( {b}_{n} \times {ω}_{k} )\end{matrix} ]$$

Meanwhile, Fourier feature embedding of a vibration signal at an intermediate point may proceed as follows. For example, in an example where there are a motor reducer mount (trans1), a subframe mount (trans2), and a shock absorber top mount (trans3), the amplitudes of vibration signals at the three intermediate points may include nine dimensions such as X_{trans1,ω0}, Y_{trans1,ω0}, Z_{trans1,ω0}, X_{trans2,ω0}, Y_{trans2,ω0}, Z_{trans2,ω0}, and X_{trans3,ω0}, Y_{trans3,ω0}, Z_{trans3,ω0}. Here, X_{trans1,ω0}, Y_{trans1,ω0}, Z_{trans1,ω0}, X_{trans2,ω0}, Y_{trans2,ω0}, Z_{trans2,ω0}, and X_{trans3,ω0}, Y_{trans3,ω0}, Z_{trans3,ω0} may be represented by matrices, respectively, as follows.

For example, when the value of b increases from 1 to n, based on ω₀, by applying a Fourier feature embedding function γ (ω, magₜᵣₐₙₛ) of a vibration signal at an intermediate point, the x-axis, y-axis, z-axis frequency data (trans1, trans2, trans3) of each intermediate point may be represented as follows.

$$[ \begin{matrix}{X}_{trans 1 , ω0} sin ( {b}_{1} \times {ω}_{0} ) \\ {X}_{trans 1 , ω0} cos ( {b}_{1} \times {ω}_{0} ) \\ {X}_{trans 1 , ω0} sin ( {b}_{2} \times {ω}_{0} ) \\ {X}_{trans 1 , ω0} cos ( {b}_{2} \times {ω}_{0} ) \\ ⋮ \\ {X}_{trans 1 , ω0} sin ( {b}_{n} \times {ω}_{0} ) \\ {X}_{trans 1 , ω0} cos ( {b}_{n} \times {ω}_{0} )\end{matrix} ] [ \begin{matrix}{Y}_{trans 1 , ω0} sin ( {b}_{1} \times {ω}_{0} ) \\ {Y}_{trans 1 , ω0} cos ( {b}_{1} \times {ω}_{0} ) \\ {Y}_{trans 1 , ω0} sin ( {b}_{2} \times {ω}_{0} ) \\ {Y}_{trans 1 , ω0} cos ( {b}_{2} \times {ω}_{0} ) \\ ⋮ \\ {Y}_{trans 1 , ω0} sin ( {b}_{n} \times {ω}_{0} ) \\ {Y}_{trans 1 , ω0} cos ( {b}_{n} \times {ω}_{0} )\end{matrix} ] [ \begin{matrix}{Z}_{trans 1 , ω0} sin ( {b}_{1} \times {ω}_{0} ) \\ {Z}_{trans 1 , ω0} cos ( {b}_{1} \times {ω}_{0} ) \\ {Z}_{trans 1 , ω0} sin ( {b}_{2} \times {ω}_{0} ) \\ {Z}_{trans 1 , ω0} cos ( {b}_{2} \times {ω}_{0} ) \\ ⋮ \\ {Z}_{trans 1 , ω0} sin ( {b}_{n} \times {ω}_{0} ) \\ {Z}_{trans 1 , ω0} cos ( {b}_{n} \times {ω}_{0} )\end{matrix} ]$$

$$[ \begin{matrix}{X}_{trans 2 , ω0} sin ( {b}_{1} \times {ω}_{0} ) \\ {X}_{trans 2 , ω0} cos ( {b}_{1} \times {ω}_{0} ) \\ {X}_{trans 2 , ω0} sin ( {b}_{2} \times {ω}_{0} ) \\ {X}_{trans 2 , ω0} cos ( {b}_{2} \times {ω}_{0} ) \\ ⋮ \\ {X}_{trans 2 , ω0} sin ( {b}_{n} \times {ω}_{0} ) \\ {X}_{trans 2 , ω0} cos ( {b}_{n} \times {ω}_{0} )\end{matrix} ] [ \begin{matrix}{Y}_{trans 2 , ω0} sin ( {b}_{1} \times {ω}_{0} ) \\ {Y}_{trans 2 , ω0} cos ( {b}_{1} \times {ω}_{0} ) \\ {Y}_{trans 2 , ω0} sin ( {b}_{2} \times {ω}_{0} ) \\ {Y}_{trans 2 , ω0} cos ( {b}_{2} \times {ω}_{0} ) \\ ⋮ \\ {Y}_{trans 2 , ω0} sin ( {b}_{n} \times {ω}_{0} ) \\ {Y}_{trans 2 , ω0} cos ( {b}_{n} \times {ω}_{0} )\end{matrix} ] [ \begin{matrix}{Z}_{trans 2 , ω0} sin ( {b}_{1} \times {ω}_{0} ) \\ {Z}_{trans 2 , ω0} cos ( {b}_{1} \times {ω}_{0} ) \\ {Z}_{trans 2 , ω0} sin ( {b}_{2} \times {ω}_{0} ) \\ {Z}_{trans 2 , ω0} cos ( {b}_{2} \times {ω}_{0} ) \\ ⋮ \\ {Z}_{trans 2 , ω0} sin ( {b}_{n} \times {ω}_{0} ) \\ {Z}_{trans 2 , ω0} cos ( {b}_{n} \times {ω}_{0} )\end{matrix} ]$$

$$[ \begin{matrix}{X}_{trans 3 , ω0} sin ( {b}_{1} \times {ω}_{0} ) \\ {X}_{trans 3 , ω0} cos ( {b}_{1} \times {ω}_{0} ) \\ {X}_{trans 3 , ω0} sin ( {b}_{2} \times {ω}_{0} ) \\ {X}_{trans 3 , ω0} cos ( {b}_{2} \times {ω}_{0} ) \\ ⋮ \\ {X}_{trans 3 , ω0} sin ( {b}_{n} \times {ω}_{0} ) \\ {X}_{trans 3 , ω0} cos ( {b}_{n} \times {ω}_{0} )\end{matrix} ] [ \begin{matrix}{Y}_{trans 3 , ω0} sin ( {b}_{1} \times {ω}_{0} ) \\ {Y}_{trans 3 , ω0} cos ( {b}_{1} \times {ω}_{0} ) \\ {Y}_{trans 3 , ω0} sin ( {b}_{2} \times {ω}_{0} ) \\ {Y}_{trans 3 , ω0} cos ( {b}_{2} \times {ω}_{0} ) \\ ⋮ \\ {Y}_{trans 3 , ω0} sin ( {b}_{n} \times {ω}_{0} ) \\ {Y}_{trans 3 , ω0} cos ( {b}_{n} \times {ω}_{0} )\end{matrix} ] [ \begin{matrix}{Z}_{trans 3 , ω0} sin ( {b}_{1} \times {ω}_{0} ) \\ {Z}_{trans 3 , ω0} cos ( {b}_{1} \times {ω}_{0} ) \\ {Z}_{trans 3 , ω0} sin ( {b}_{2} \times {ω}_{0} ) \\ {Z}_{trans 3 , ω0} cos ( {b}_{2} \times {ω}_{0} ) \\ ⋮ \\ {Z}_{trans 3 , ω0} sin ( {b}_{n} \times {ω}_{0} ) \\ {Z}_{trans 3 , ω0} cos ( {b}_{n} \times {ω}_{0} )\end{matrix} ]$$

When the value of b increases from 1 to n, based on ω₁, the x-axis, y-axis, z-axis frequency data (trans1, trans2, trans3) of each intermediate point may be represented as follows.

$$[ \begin{matrix}{X}_{trans 1 , ω1} sin ( {b}_{1} \times {ω}_{1} ) \\ {X}_{trans 1 , ω1} cos ( {b}_{1} \times {ω}_{1} ) \\ {X}_{trans 1 , ω1} sin ( {b}_{2} \times {ω}_{1} ) \\ {X}_{trans 1 , ω1} cos ( {b}_{2} \times {ω}_{1} ) \\ ⋮ \\ {X}_{trans 1 , ω1} sin ( {b}_{n} \times {ω}_{1} ) \\ {X}_{trans 1 , ω1} cos ( {b}_{n} \times {ω}_{1} )\end{matrix} ] [ \begin{matrix}{Y}_{trans 1 , ω1} sin ( {b}_{1} \times {ω}_{1} ) \\ {Y}_{trans 1 , ω1} cos ( {b}_{1} \times {ω}_{1} ) \\ {Y}_{trans 1 , ω1} sin ( {b}_{2} \times {ω}_{1} ) \\ {Y}_{trans 1 , ω1} cos ( {b}_{2} \times {ω}_{1} ) \\ ⋮ \\ {Y}_{trans 1 , ω1} sin ( {b}_{n} \times {ω}_{1} ) \\ {Y}_{trans 1 , ω1} cos ( {b}_{n} \times {ω}_{1} )\end{matrix} ] [ \begin{matrix}{Z}_{trans 1 , ω1} sin ( {b}_{1} \times {ω}_{1} ) \\ {Z}_{trans 1 , ω1} cos ( {b}_{1} \times {ω}_{1} ) \\ {Z}_{trans 1 , ω1} sin ( {b}_{2} \times {ω}_{1} ) \\ {Z}_{trans 1 , ω1} cos ( {b}_{2} \times {ω}_{1} ) \\ ⋮ \\ {Z}_{trans 1 , ω1} sin ( {b}_{n} \times {ω}_{1} ) \\ {Z}_{trans 1 , ω1} cos ( {b}_{n} \times {ω}_{1} )\end{matrix} ]$$

$$[ \begin{matrix}{X}_{trans 2 , ω1} sin ( {b}_{1} \times {ω}_{1} ) \\ {X}_{trans 2 , ω1} cos ( {b}_{1} \times {ω}_{1} ) \\ {X}_{trans 2 , ω1} sin ( {b}_{2} \times {ω}_{1} ) \\ {X}_{trans 2 , ω1} cos ( {b}_{2} \times {ω}_{1} ) \\ ⋮ \\ {X}_{trans 2 , ω1} sin ( {b}_{n} \times {ω}_{1} ) \\ {X}_{trans 2 , ω1} cos ( {b}_{n} \times {ω}_{1} )\end{matrix} ] [ \begin{matrix}{Y}_{trans 2 , ω1} sin ( {b}_{1} \times {ω}_{1} ) \\ {Y}_{trans 2 , ω1} cos ( {b}_{1} \times {ω}_{1} ) \\ {Y}_{trans 2 , ω1} sin ( {b}_{2} \times {ω}_{1} ) \\ {Y}_{trans 2 , ω1} cos ( {b}_{2} \times {ω}_{1} ) \\ ⋮ \\ {Y}_{trans 2 , ω1} sin ( {b}_{n} \times {ω}_{1} ) \\ {Y}_{trans 2 , ω1} cos ( {b}_{n} \times {ω}_{1} )\end{matrix} ] [ \begin{matrix}{Z}_{trans 2 , ω1} sin ( {b}_{1} \times {ω}_{1} ) \\ {Z}_{trans 2 , ω1} cos ( {b}_{1} \times {ω}_{1} ) \\ {Z}_{trans 2 , ω1} sin ( {b}_{2} \times {ω}_{1} ) \\ {Z}_{trans 2 , ω1} cos ( {b}_{2} \times {ω}_{1} ) \\ ⋮ \\ {Z}_{trans 2 , ω1} sin ( {b}_{n} \times {ω}_{1} ) \\ {Z}_{trans 2 , ω1} cos ( {b}_{n} \times {ω}_{1} )\end{matrix} ]$$

$$[ \begin{matrix}{X}_{trans 3 , ω1} sin ( {b}_{1} \times {ω}_{1} ) \\ {X}_{trans 3 , ω1} cos ( {b}_{1} \times {ω}_{1} ) \\ {X}_{trans 3 , ω1} sin ( {b}_{2} \times {ω}_{1} ) \\ {X}_{trans 3 , ω1} cos ( {b}_{2} \times {ω}_{1} ) \\ ⋮ \\ {X}_{trans 3 , ω1} sin ( {b}_{n} \times {ω}_{1} ) \\ {X}_{trans 3 , ω1} cos ( {b}_{n} \times {ω}_{1} )\end{matrix} ] [ \begin{matrix}{Y}_{trans 3 , ω1} sin ( {b}_{1} \times {ω}_{1} ) \\ {Y}_{trans 3 , ω1} cos ( {b}_{1} \times {ω}_{1} ) \\ {Y}_{trans 3 , ω1} sin ( {b}_{2} \times {ω}_{1} ) \\ {Y}_{trans 3 , ω1} cos ( {b}_{2} \times {ω}_{1} ) \\ ⋮ \\ {Y}_{trans 3 , ω1} sin ( {b}_{n} \times {ω}_{1} ) \\ {Y}_{trans 3 , ω1} cos ( {b}_{n} \times {ω}_{1} )\end{matrix} ] [ \begin{matrix}{Z}_{trans 3 , ω1} sin ( {b}_{1} \times {ω}_{1} ) \\ {Z}_{trans 3 , ω1} cos ( {b}_{1} \times {ω}_{1} ) \\ {Z}_{trans 3 , ω1} sin ( {b}_{2} \times {ω}_{1} ) \\ {Z}_{trans 3 , ω1} cos ( {b}_{2} \times {ω}_{1} ) \\ ⋮ \\ {Z}_{trans 3 , ω1} sin ( {b}_{n} \times {ω}_{1} ) \\ {Z}_{trans 3 , ω1} cos ( {b}_{n} \times {ω}_{1} )\end{matrix} ]$$

When the value of b increases from 1 to n, based on ωₖ as the value of i in ωᵢ increases the value of k, the x-axis, y-axis, z-axis frequency data (trans1, trans2, trans3) of each intermediate point may be represented as follows.

$$[ \begin{matrix}{X}_{trans 1 , ω k} sin ( {b}_{1} \times {ω}_{k} ) \\ {X}_{trans 1 , ω k} cos ( {b}_{1} \times {ω}_{k} ) \\ {X}_{trans 1 , ω k} sin ( {b}_{2} \times {ω}_{k} ) \\ {X}_{trans 1 , ω k} cos ( {b}_{2} \times {ω}_{k} ) \\ ⋮ \\ {X}_{trans 1 , ω k} sin ( {b}_{n} \times {ω}_{k} ) \\ {X}_{trans 1 , ω k} cos ( {b}_{n} \times {ω}_{k} )\end{matrix} ] [ \begin{matrix}{Y}_{trans 1 , ω k} sin ( {b}_{1} \times {ω}_{k} ) \\ {Y}_{trans 1 , ω k} cos ( {b}_{1} \times {ω}_{k} ) \\ {Y}_{trans 1 , ω k} sin ( {b}_{2} \times {ω}_{k} ) \\ {Y}_{trans 1 , ω k} cos ( {b}_{2} \times {ω}_{k} ) \\ ⋮ \\ {Y}_{trans 1 , ω k} sin ( {b}_{n} \times {ω}_{k} ) \\ {Y}_{trans 1 , ω k} cos ( {b}_{n} \times {ω}_{k} )\end{matrix} ] [ \begin{matrix}{Z}_{trans 1 , ω k} sin ( {b}_{1} \times {ω}_{k} ) \\ {Z}_{trans 1 , ω k} cos ( {b}_{1} \times {ω}_{k} ) \\ {Z}_{trans 1 , ω k} sin ( {b}_{2} \times {ω}_{k} ) \\ {Z}_{trans 1 , ω k} cos ( {b}_{2} \times {ω}_{k} ) \\ ⋮ \\ {Z}_{trans 1 , ω k} sin ( {b}_{n} \times {ω}_{k} ) \\ {Z}_{trans 1 , ω k} cos ( {b}_{n} \times {ω}_{k} )\end{matrix} ]$$

$$[ \begin{matrix}{X}_{trans 2 , ω k} sin ( {b}_{1} \times {ω}_{k} ) \\ {X}_{trans 2 , ω k} cos ( {b}_{1} \times {ω}_{k} ) \\ {X}_{trans 2 , ω k} sin ( {b}_{2} \times {ω}_{k} ) \\ {X}_{trans 2 , ω k} cos ( {b}_{2} \times {ω}_{k} ) \\ ⋮ \\ {X}_{trans 2 , ω k} sin ( {b}_{n} \times {ω}_{k} ) \\ {X}_{trans 2 , ω k} cos ( {b}_{n} \times {ω}_{k} )\end{matrix} ] [ \begin{matrix}{Y}_{trans 2 , ω k} sin ( {b}_{1} \times {ω}_{k} ) \\ {Y}_{trans 2 , ω k} cos ( {b}_{1} \times {ω}_{k} ) \\ {Y}_{trans 2 , ω k} sin ( {b}_{2} \times {ω}_{k} ) \\ {Y}_{trans 2 , ω k} cos ( {b}_{2} \times {ω}_{k} ) \\ ⋮ \\ {Y}_{trans 2 , ω k} sin ( {b}_{n} \times {ω}_{k} ) \\ {Y}_{trans 2 , ω k} cos ( {b}_{n} \times {ω}_{k} )\end{matrix} ] [ \begin{matrix}{Z}_{trans 2 , ω k} sin ( {b}_{1} \times {ω}_{k} ) \\ {Z}_{trans 2 , ω k} cos ( {b}_{1} \times {ω}_{k} ) \\ {Z}_{trans 2 , ω k} sin ( {b}_{2} \times {ω}_{k} ) \\ {Z}_{trans 2 , ω k} cos ( {b}_{2} \times {ω}_{k} ) \\ ⋮ \\ {Z}_{trans 2 , ω k} sin ( {b}_{n} \times {ω}_{k} ) \\ {Z}_{trans 2 , ω k} cos ( {b}_{n} \times {ω}_{k} )\end{matrix} ]$$

$$[ \begin{matrix}{X}_{trans 3 , ω k} sin ( {b}_{1} \times {ω}_{k} ) \\ {X}_{trans 3 , ω k} cos ( {b}_{1} \times {ω}_{k} ) \\ {X}_{trans 3 , ω k} sin ( {b}_{2} \times {ω}_{k} ) \\ {X}_{trans 3 , ω k} cos ( {b}_{2} \times {ω}_{k} ) \\ ⋮ \\ {X}_{trans 3 , ω k} sin ( {b}_{n} \times {ω}_{k} ) \\ {X}_{trans 3 , ω k} cos ( {b}_{n} \times {ω}_{k} )\end{matrix} ] [ \begin{matrix}{Y}_{trans 3 , ω k} sin ( {b}_{1} \times {ω}_{k} ) \\ {Y}_{trans 3 , ω k} cos ( {b}_{1} \times {ω}_{k} ) \\ {Y}_{trans 3 , ω k} sin ( {b}_{2} \times {ω}_{k} ) \\ {Y}_{trans 3 , ω k} cos ( {b}_{2} \times {ω}_{k} ) \\ ⋮ \\ {Y}_{trans 3 , ω k} sin ( {b}_{n} \times {ω}_{k} ) \\ {Y}_{trans 3 , ω k} cos ( {b}_{n} \times {ω}_{k} )\end{matrix} ] [ \begin{matrix}{Z}_{trans 3 , ω k} sin ( {b}_{1} \times {ω}_{k} ) \\ {Z}_{trans 3 , ω k} cos ( {b}_{1} \times {ω}_{k} ) \\ {Z}_{trans 3 , ω k} sin ( {b}_{2} \times {ω}_{k} ) \\ {Z}_{trans 3 , ω k} cos ( {b}_{2} \times {ω}_{k} ) \\ ⋮ \\ {Z}_{trans 3 , ω k} sin ( {b}_{n} \times {ω}_{k} ) \\ {Z}_{trans 3 , ω k} cos ( {b}_{n} \times {ω}_{k} )\end{matrix} ]$$

According to a result of the Fourier feature embedding of vibration signal data at each intermediate point, it may be transformed into x-axis, y-axis, and z-axis vibration signals (X_{drive,ω0}, Y_{drive,ω0}, Z_{drive,ω0}) at a drivetrain, i.e., the noise point.

For example, when a vibration amplitude corresponding to a 60th order component is input, the embedding through a total of 512 values of b may be shown in FIG. 5.

When a vibration/noise signal of the 60th order is input, the Fourier feature embedding with a total of 512 values of b may be represented as follows. When a frequency component U of the vibration/noise signal and an amplitude data value A are input, amplitude data of the frequency component may be embedded into a high-dimensional feature factor. The value of b may be used as a hyperparameter in the embedding to indicate the number of nodes included in a layer. Here, hyperparameters, which are values that are manually adjusted as a model learns, may be determined before the learning begins. In other words, they may be predetermined by a user, unlike weights and biases that are obtained from data. In this example, b may be set to 512.

Here, input data may be sampled into as many as n from a N (0, σ²) normal distribution and then be embedded. In other words, sampling it from the N (0, σ²) normal distribution may indicate randomly extracting data from a distribution with a specific mean value and standard deviation σ. When embedding data sampled from a normal distribution, it may be used to initialize weights of a deep learning model. The weights may be initialized with values sampled from the normal distribution.

$$γ ( {ω}_{60} , {A}_{ω60} ) = [ \begin{matrix}{A}_{ω60} sin ( {b}_{1} \times {ω}_{60} ) \\ {A}_{ω60} cos ( {b}_{1} \times {ω}_{60} ) \\ {A}_{ω60} sin ( {b}_{2} \times {ω}_{60} ) \\ {A}_{ω60} cos ( {b}_{2} \times {ω}_{60} ) \\ ⋮ \\ {A}_{ω60} sin ( {b}_{n} \times {ω}_{60} ) \\ {A}_{ω60} cos ( {b}_{n} \times {ω}_{60} )\end{matrix} ] \text{?}$$

Referring back to FIG. 2, the input unit 10 may obtain a vibration/noise signal from the noise-receiving point, i.e., the driver's seat, at a diagnosis time (i.e., testing time) for diagnosing a failure in the drivetrain of the mobility apparatus (S200) (\textcircled{5} in FIG. 1). The control unit 30 may generate noise-receiving point data, which is obtained by transforming a time-domain vibration signal measured from the noise-receiving point into a frequency domain (S300). The control unit 30 may transform frequency data into a high-dimensional feature factor by Fourier feature embedding based on the noise-receiving point data (S400).

Here, the Fourier feature embedding operation performed by the control unit 30 may be similar to the Fourier feature embedding in the prediction model training unit 20 as described above. However, there is a difference in that the Fourier feature embedding operation performed by the control unit 30 targets vibration/noise signals of the noise-receiving point and the intermediate point extracted at the testing time, while the Fourier feature embedding operation performed by the prediction model training unit 20 targets vibration/noise signals of the noise-receiving point and the intermediate point used to train the transfer function estimation model.

Although the prediction model training unit 20 and the control unit 30 are shown as different components, they may refer to components separated by the features of software operating at different times on a single “processor.”

The control unit 30 may receive the transfer function estimation model stored in the storage unit 40 (S500).

The control unit 30 may predict noise point data by applying, to the transfer function estimation model, the noise-receiving point data with a signal feature transformed into the high-dimensional feature factor by the Fourier feature embedding operation. In other words, the control unit 30 may predict data indicative of vibration of the noise point from a vibration/noise signal at the noise-receiving point at a current time for testing through the transfer function estimation model trained from data indicative of vibration of the noise point, the intermediate point, and the noise-receiving point measured at the learning time (S600).

The control unit 30 may determine the validity based on the predicted noise point data. Since the data is the noise point data obtained by the transfer function estimation model, the validity may also refer to the validity of the transfer function estimation model. For example, vibration/noise data measured at the noise-receiving point at a time of model generation by the prediction model training unit 20 may be matched with vibration/noise data measured at the noise point and each intermediate point. Based on this, the control unit 30 may predict the noise point data by inputting the noise-receiving point data measured at the testing time into the transfer function estimation model and may compare the predicted data to the vibration/noise data of the noise point matched in the transfer function estimation learning process. Based on a result of the comparison, the validity of the predicted noise point data (i.e., the validity of the transfer function estimation model) may be determined (S700).

Furthermore, when the predicted noise point data is valid, the control unit 30 may determine a degree of failure (e.g., a degree of deterioration) at the noise point, that is, the control unit 30 may determine whether the noise point, i.e., the drivetrain, is in a normal state. For example, based on the predicted noise point data, the control unit 30 may compare vibration signals collected from the noise point, the at least one intermediate point, and the noise-receiving point to data indicating failure information of the motor reducer at a time of measuring each of the vibration signals. Based on a result of the comparison, the control unit 30 may determine a degree of failure of the noise point when the predicted noise point data is valid. Here, the input unit 10 may receive, from outside, the data indicating the failure information of the motor reducer corresponding to a time of measuring each of the vibration signals. In another example, the data indicating the failure information of the motor reducer at the time of measurement may be stored in advance in the storage unit 40. The storage unit 40 may match the vibration/noise data of the drivetrain by vehicle type with corresponding failure information of the drivetrain and store it. For example, the information stored in the storage unit 40 may include a type of failure, along with a degree of failure of the drivetrain corresponding to the vibration/noise data.

The control unit 30 may display, in a form recognizable by a user, information as to whether the predicted noise point data is valid and the degree of failure (e.g., the degree of deterioration) at the noise point (e.g., the drivetrain) based on the result of the comparison. For example, it may visually display, through a cluster of the vehicle, a predicted failure point including a degree of deterioration or a predicted lifespan of the motor reducer. The displayed information may be provided in the form of voice through speakers, or the information may be displayed on a portable terminal of a driver in some cases.

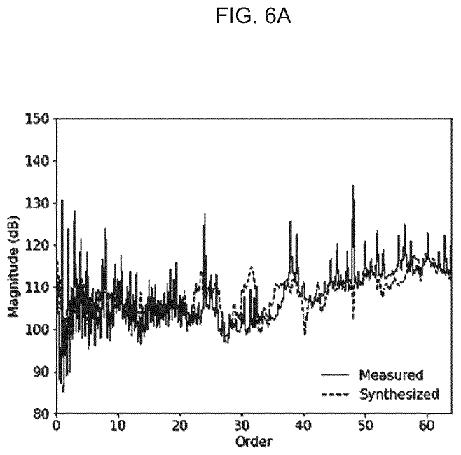

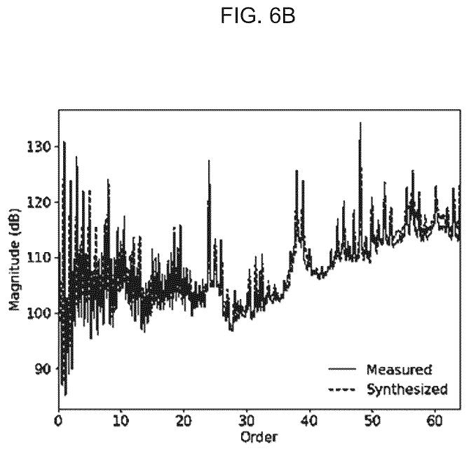

FIGS. 6A and 6B are schematic diagrams illustrating, respectively, a comparative example with Fourier feature embedding not applied and an example of a predicted drivetrain signal by a transfer function model by deep learning with the Fourier feature embedding applied according to an embodiment of the present disclosure.

FIG. 6A illustrates a predicted drivetrain signal by a transfer function model with Fourier feature embedding not applied, and FIG. 6B illustrates a predicted drivetrain signal by a transfer function model by deep learning with Fourier feature embedding applied according to an embodiment of the present disclosure. As shown, a predicted value (Synthesized) by the transfer function model with the Fourier feature embedding applied as and an measured value (Measured) are highly consistent.

As described above, the mobility apparatus drivetrain failure diagnosing apparatus and method according to embodiments of the present disclosure may solve a spectral bias-induced challenge by applying Fourier feature embedding, determine abnormality of a drivetrain of a mobility apparatus by predicting noise point data using noise and vibration signals of a noise-receiving point at an arbitrary point in time, and accurately determine and respond to deterioration of the drivetrain of the mobility apparatus, thereby reducing the time and cost used for vehicle maintenance, increasing driving sensitivity of a vehicle driver, and improving a vehicle customer's satisfaction.

While preferred embodiments of the present disclosure have been shown and described above, the present disclosure is not limited to the specific embodiments described above, and various changes and modifications may be made by one of ordinary skill in the art to which the present disclosure pertains without departing from the spirit and scope of the disclosure set forth in the following patent claims.

What is claimed is:

1. An apparatus for diagnosing a mobility apparatus, the apparatus comprising:
an input unit including one or more sensors configured to obtain a first noise or vibration signal at a first point while a driving force of the mobility apparatus is generated;
a control unit configured to:
transform the first noise or vibration signal into a frequency-domain signal and obtain one or more high-dimensional feature factors by a Fourier feature embedding neural network, and
predict noise or vibration data for a component in association with the driving force using a transfer function estimation model and diagnose the component based on the noise or vibration data; and
a display unit configured to display a predicting result and a diagnosing result in one or more of a display form that is visually recognizable by a driver.

2. The apparatus of claim 1, further comprising:
a prediction model training unit configured to determine a transfer path of noise or vibration from a second point to the first point and generate the transfer function estimation model by transforming frequency data of the first noise or vibration signal and a second noise or vibration signal obtained at the second point into one or more high-dimensional feature factors through the Fourier feature embedding neural network; and
a storage unit configured to store information about the transfer function estimation model.

3. The apparatus of claim 1, wherein the Fourier feature embedding is configured to transform a result of a Fourier transformation into a high-dimensional feature vector with a nonlinear transformation applied.

4. The apparatus of claim 2, wherein the prediction model training unit is further configured to generate:
a first transfer function estimation model configured to generate frequency data indicative of noise or vibration at an intermediate point between the first point and the second point using the frequency data of the first noise or vibration signal based on a second noise or vibration signal and a third noise or vibration signal obtained at the intermediate point; and
a second transfer function estimation model configured to generate the frequency data of the second noise or vibration signal using the frequency data indicative of the noise or vibration at the intermediate point based on the third noise or vibration signal and the first noise or vibration signal.

5. The apparatus of claim 1, wherein the transfer function estimation model comprises a plurality of computational blocks and at least a fully connected block, and
wherein each of the plurality of computational blocks is subject to a kernel.

6. The apparatus of claim 2, wherein the transfer function estimation model comprises a plurality of computational blocks and at least a fully connected block,
wherein each of the plurality of computational blocks is subject to a kernel, and
wherein the prediction model training unit is further configured to determine weights and biases of the kernel through deep learning.

7. The apparatus of claim 2, wherein the second point comprises a point in association with obtaining a noise or vibration signal for a motor reducer, a brake, a tire, or any combination of the motor reducer, the brake, the tire in the mobility apparatus, and
wherein the first point comprises a point at a driver's seat of the mobility apparatus.

8. The apparatus of claim 4, wherein the second point includes a point at a motor or a reducer, and the intermediate point includes a point at each of a motor or reducer mount, a subframe mount, or a shock absorber top mount.

9. The apparatus of claim 8, wherein the input unit is further configured to:
obtain the first noise or vibration signal from at least a first sensor located within a predetermined range from the first point,
obtain the second noise or vibration signal from at least a second sensor located within a predetermined range from the second point, and
obtain the third noise or vibration signal from a third sensor located within a predetermined range from the intermediate point.

10. The apparatus of claim 1, wherein the input unit is further configured to receive, from an external device, data indicative of failure information of a motor or a reducer.

11. The apparatus of claim 9, wherein the storage unit is further configured to store the first noise or vibration signal, the second noise or vibration signal, the third noise or vibration signal, or data indicative of failure information of a motor or a reducer at a time of measuring the first noise or vibration signal, the second noise or vibration signal, or the third noise or vibration signal.

12. The apparatus of claim 2, wherein the prediction model training unit is further configured to train the Fourier feature embedding neural network with a spectrum with a data length of 640 as a batch size for 1350 iterations and use an adaptive moment estimation (Adam) algorithm to minimize a loss function.

13. A method of diagnosing a mobility apparatus, the method comprising:
generating first point data transformed into a frequency domain from a first noise or vibration signal measured at a first point while a driving force of the mobility apparatus is generated;
transforming frequency data of the first point data into one or more high-dimensional feature factors by a Fourier feature embedding neural network;
reading a transfer function estimation model stored in a storage unit;
predicting second point data for a second point by applying, to the transfer function estimation model, the one or more high-dimensional feature factors; and
determining validity of the predicted second point data.

14. The method of claim 13, further comprising:
training the Fourier feature embedding neural network to generate the transfer function estimation model.

15. The method of claim 13, further comprising:
displaying a result of determining the validity of the second point data in a form recognizable by a driver.

16. The method of claim 13, further comprising:
generating intermediate point data transformed into the frequency domain from a third noise or vibration signal obtained by at least an intermediate point between the first point and the second point,
wherein the transfer function estimation model comprises:
a first transfer function estimation model configured to generate frequency data indicative of noise or vibration of the intermediate point from the frequency data of the first noise or vibration signal based on a second noise or vibration signal obtained at the second point and the third noise or vibration signal; and
a second transfer function estimation model configured to generate frequency data indicative of the second noise or vibration from the frequency data indicative of the noise or vibration of the intermediate point based on the third noise or vibration signal and the first noise or vibration signal.

17. The method of claim 13, wherein the transfer function estimation model comprises a plurality of computational blocks and at least a fully connected block, and
wherein each of the plurality of computational blocks is subjected to a kernel.

18. The method of claim 17, wherein weights and biases of the kernel are determined through deep learning.

19. The method of claim 16, wherein the second point includes a point at a motor or a reducer, and the intermediate point includes a point at each of a motor or reducer mount, a subframe mount, or a shock absorber top mount.

20. A vehicle diagnosing system for diagnosing a mobility apparatus, the vehicle diagnosing system comprising:
an input unit configured to obtain a first noise or vibration signal at a first point while a driving force of the mobility apparatus is generated;
a control unit configured to transform the first noise or vibration signal into a frequency-domain signal, extract one or more high-dimensional feature factors by a Fourier feature embedding neural network, predict noise or vibration data for a component using a transfer function estimation model, and diagnose whether the component based on the noise or vibration data is in a normal state; and
a display unit configured to display a prediction result and a validity determination result of predicted data in a display form recognizable to a driver of a vehicle.
